(19) United States
(12) Patent Application Publication
(10) Pub. No.: US 2015/0261810 A1
(43) Pub. Date: Sep. 17, 2015

(54) DATA TRANSFER APPARATUS AND METHOD

(71) Applicant: ELECTRONICS AND TELECOMMUNICATIONS RESEARCH INSTITUTE, Daejeon (KR)

(72) Inventors: Kyoung-Ho KIM, Gokseong-gun (KR); Jeong-Han YUN, Daejeon (KR); Heemin KIM, Daejeon (KR); Woonyon KIM, Daejeon (KR); Jungtaek SEO, Daejeon (KR); Eung Ki PARK, Daejeon (KR)

(21) Appl. No.: 14/561,783

(22) Filed: Dec. 5, 2014

(30) Foreign Application Priority Data
Mar. 13, 2014 (KR) 10-2014-0029537

(51) Int. Cl. G06F 17/30; G06F 21/62

(52) U.S. Cl. CPC G06F 17/30371; G06F 21/6218

(57) ABSTRACT

A data transfer apparatus and method, which fundamentally prevent the possibility of intrusion from an external network into an internal network that provides files, thus enabling data to be reliability transferred in a situation in which information cannot be exchanged. The data transfer apparatus includes an internal network connection unit for receiving data from a host of an internal network. An internal network control unit for performing control such that the data is unidirectionally transmitted. A write control unit checks integrity of the data received from the internal network control unit and detects status of the storage unit. An external network connection unit receives a request from a host of an external network. A read/write control unit searches for, reads, and deletes data stored in the storage unit at a request of the external network host.

### CROSS REFERENCE TO RELATED APPLICATION

This application claims the benefit of Korean Patent Application No. 10-2014-0029537, filed Mar. 13, 2014, which is hereby incorporated by reference in its entirety into this application.

### BACKGROUND OF THE INVENTION

1. Technical Field

The present invention relates generally to a data transfer apparatus and method and, more particularly, to a data transfer apparatus and method, which fundamentally prevent the possibility of intrusion from an external network into an internal network that provides files, thus enabling data to be reliability transferred in a situation in which information cannot be exchanged.

2. Description of the Related Art

Recently, with an increase in cyber threats, network separation technology for protecting internal networks has become an issue of concern, and thus various types of network separation technologies have been developed.

Unidirectional (one-way) data transmission technology is one of such network separation technologies. Unidirectional data transmission technology is divided into logical unidirectional data transmission technology and physical unidirectional data transmission technology depending on the implementation method.

Logical unidirectional data transmission technology may enable intrusion from an external network due to the vulnerability of a transmission structure itself, problems in implementation, etc. In contrast, physical unidirectional data transmission technology is advantageous in that even if a network is attacked, it is impossible to make intrusion from an external network into an internal network. However, since the transmitting side does not know the status of the receiving side, the reliability of transmitted data cannot be guaranteed.

A physical unidirectional data transfer system based on physical unidirectional data transmission technology is network security equipment for physically preventing the transmission of data from an external network to an internal network while enabling the transmission of data from the internal network to the external network, thus fundamentally blocking intrusion occurring via the external network.

For example, Korean Patent Application Publication No. 10-2011-0040004 entitled “Unidirectional data transmission system and method” discloses unidirectional data transmission technology which maintains security by removing the possibility of intrusion itself into a network requiring a high security level.

Physical unidirectional data transmission technology includes technology for cutting and exploiting the reception (RX) line of an Unshielded Twisted Pair (UTP) cable, technology for cutting and exploiting a serial cable, technology for eliminating the RX line of a photoconverter, etc. However, such a scheme for cutting a line and physically transmitting unidirectional data has a risk of data loss. In order to compensate for such data loss, data can be transmitted using a method of adjusting the size of a buffer and a transfer rate, a method of using a separate control line (using data), or the like. However, in a situation in which the status of the receiving side is not known, such a buffer size or transfer rate adjustment method is not a perfect countermeasure. Further, the method of using a separate circuit line has the possibility of misusing the control line itself as an intrusion path.

### SUMMARY OF THE INVENTION

Accordingly, the present invention has been made keeping in mind the above problems occurring in the prior art, and an object of the present invention is to provide a data transfer apparatus and method, which fundamentally prevent the possibility of intrusion from an external network into an internal network that provides files, and guarantee the reliability of data in a situation in which information cannot be exchanged.

In accordance with an aspect of the present invention to accomplish the above object, there is provided a data transfer method, including receiving, by a data transfer apparatus, login information from a host of an internal network, and determining an access right of the internal network host based on the received login information; if the internal network host has the access right, permitting transmission of data; detecting status of a storage unit corresponding to an area for storing the data; if the status of the storage unit is normal, receiving the data from the internal network host, temporarily storing the data, and checking integrity of the temporarily stored data; and storing the temporarily stored data in the storage unit.

Checking the integrity of the temporarily stored data may include checking, by an internal network control unit of the data transfer apparatus, integrity of the temporarily stored data; unidirectionally transmitting, by the internal network control unit, the temporarily stored data to a write control unit of the data transfer apparatus; and checking, by the write control unit, the integrity of the temporarily stored data.

Checking the integrity of the temporarily stored data may include checking the integrity of the temporarily stored data using a Message Digest Algorithm 5 (MD5) value of the login information.

In accordance with another aspect of the present invention to accomplish the above object, there is provided a data transfer method, including receiving, by a data transfer apparatus, login information from a host of an external network, and determining an access right of the external network host based on the received login information; if the external network host has the access right, receiving a data transmission request from the external network host; detecting status of a storage unit for storing data; and if the status of the storage unit is normal, reading data corresponding to the data transmission request from the storage unit and transferring the data to the external network host.

The data transfer method may further include, if the external network host has the access right, receiving a data search request from the external network host; searching the storage unit for data corresponding to the data search request; and transferring results of the search to the external network host.

The data transfer method may further include, if the external network host has the access right, receiving a data deletion request from the external network host; searching the storage unit for data corresponding to the data deletion request; and deleting found data from the storage unit, and transferring results of deleting the data to the external network host.

In accordance with a further aspect of the present invention to accomplish the above object, there is provided a data transfer apparatus, including a storage unit corresponding to an area for storing data, including an internal network connection unit for receiving data from a host of an internal network; an internal network control unit for performing control such that the data is unidirectionally transmitted; a write control unit for checking integrity of the data received from the internal network control unit and detecting status of the storage unit; an external network connection unit for receiving a request from a host of an external network; and a read/write control unit for searching for, reading, and deleting data stored in the storage unit at a request of the external network host.

The data transfer apparatus may further include a user input processing unit for processing data input via manual operation by a user.

The internal network control unit may include a data reception module for receiving data from the internal network connection unit; a unidirectional data transmission module for checking integrity of data received by the data reception module, and transferring the data to the write control unit via a unidirectional section; and a control signal reception and control module for receiving a control signal corresponding to completion of data storage from the write control unit, and transferring the received control signal to the internal network host, thus notifying the internal network host that transmission of the data has been completed.

The write control unit may include a unidirectional data reception module for receiving data from the internal network control unit; a store and storage area control module for checking integrity of the data, and storing the data in the storage unit if there is no problem with the integrity of the data as a result of checking the integrity; and a control signal transmission and control module for transmitting a control signal corresponding to completion of data storage to the internal network control unit.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a configuration diagram schematically showing a data transfer apparatus according to an embodiment of the present invention;

FM. 2 is a flow diagram showing a procedure, in which the data transfer apparatus receives a file from the host of an internal network, with respect to individual steps according to an embodiment of the present invention;

FIG. 3 is a flowchart showing a procedure for receiving a file from the standpoint of the data transfer apparatus according to an embodiment of the present invention;

FIG. 4 is a flow diagram showing a procedure in which the data transfer apparatus transfers a file to the host of an external network according to an embodiment of the present invention;

FIG. 5 is a flowchart showing a procedure for transferring a file from the standpoint of the data transfer apparatus according to an embodiment of the present invention;

FIG. 6 is a configuration diagram showing an internal network control unit and a write control unit according to an embodiment of the present invention;

FIG. 7 is a flow diagram showing a detailed procedure, in which the data transfer apparatus receives a file from the host of an internal network, with respect to individual steps, according to an embodiment of the present invention;

FIG. 8 is a configuration diagram showing an external network control unit and a read/write control unit according to an embodiment of the present invention;

FIG. 9 is a flow diagram showing an operating procedure performed when the data transfer apparatus receives a data search request from the host of an external network according to an embodiment of the present invention;

FIG. 10 is a flow diagram showing an operating procedure performed when the data transfer apparatus receives a data reception request from the host of the external network according to an embodiment of the present invention; and

FIG. 11 is a flow diagram showing an operating procedure performed when the data transfer apparatus receives a data deletion request from the host of the external network according town embodiment of the present invention.

### DESCRIPTION OF THE PREFERRED EMBODIMENTS

The present invention will be described in detail below with reference to the accompanying drawings. Repeated descriptions and descriptions of known functions and configurations which have been deemed to make the gist of the present invention unnecessarily obscure will be omitted below. The embodiments of the present invention are intended to fully describe the present invention to a person having ordinary knowledge in the art to which the present invention pertains. Accordingly, the shapes, sizes, etc. of components in the drawings may be exaggerated to make the description clearer.

Hereinafter a data transfer apparatus and method according to an embodiment of the present invention will be described in detail with reference to the attached drawings.

First, a data transfer apparatus according to an embodiment of the present invention relates to Physical One-Way Sharing Storage (FOSS) technology capable of reliability transmitting data (file) while guaranteeing physical unidirectionality.

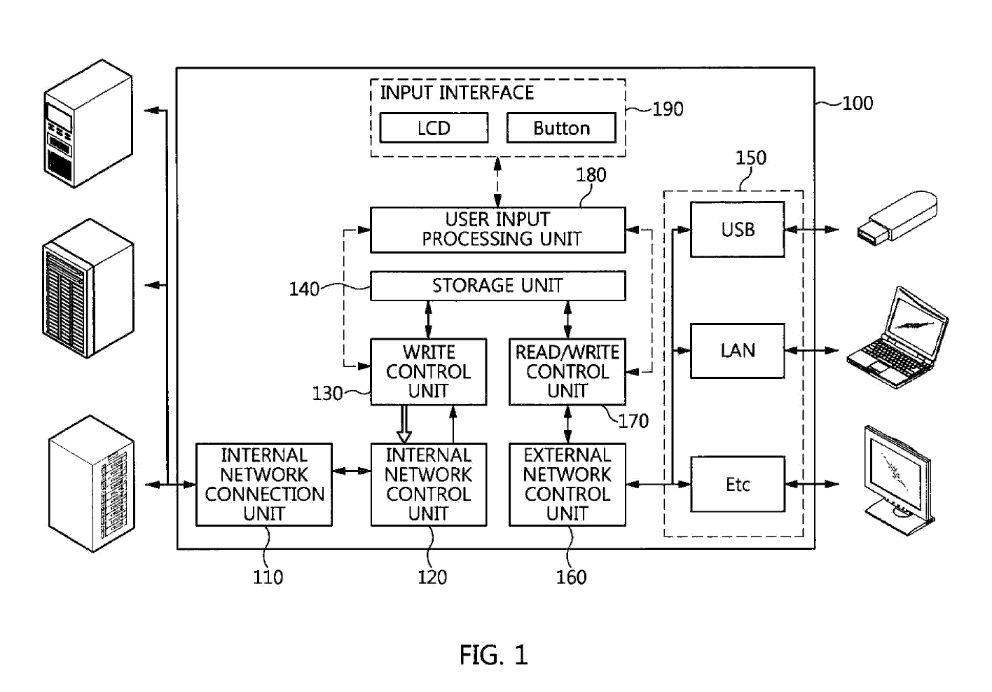

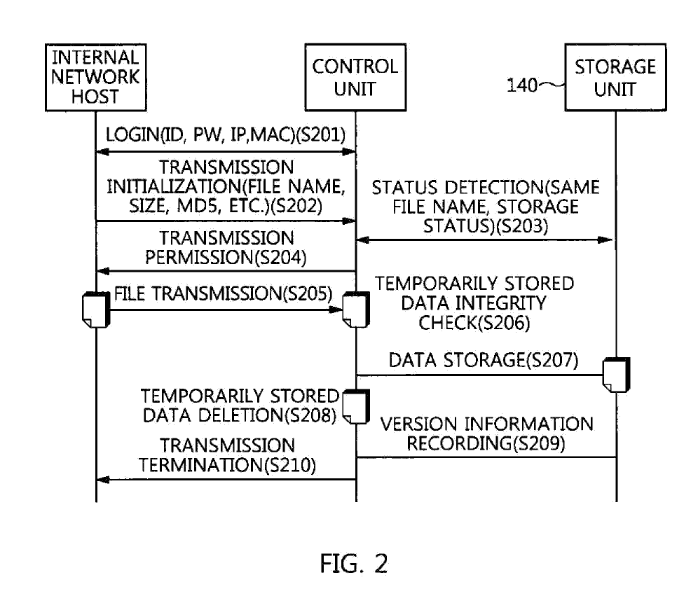

FIG. 1 is a configuration diagram schematically showing a data transfer apparatus according to an embodiment of the present invention.

Referring to FIG. 1, a data transfer apparatus 100 includes an internal network connection unit 110, an internal network control unit 120, a write control unit 130, a storage unit 140, an external network connection unit 150, an external network control unit 160, a read/write control unit 170, a user input processing unit 180, and an input interface 190.

The internal network connection unit 110 receives data (file) from the host of an internal network, and transfers the received data (file) to the internal network control unit 120.

The internal network control unit 120 receives the data (file) from the internal network connection unit 110 and unidirectionally transmits the received data (file) to the write control unit 130. Further, the internal network control unit 120 receives a control signal from the write control unit 130 and operates in response to the received control signal.

The write control unit 130 unidirectionally receives the data (file) from the internal network control unit 120, and records the received data (file) in the storage unit 140. The write control unit 130 may check the integrity of the received data (file), store and search for the data (file), and manage the version of the file.

Further, the write control unit 130 detects the status of the storage unit 140.

The storage unit 140 functions as storage for storing the data (file).

The external network connection unit 150 receives the data (file) from the host of the external network, and transfers data (file) to be transmitted to the host of the external network. The external network connection unit 150 may be, but is not limited to, any one of a Universal Serial Bus (USB), a Local Area Network (LAN), etc.

The external network control unit 160 transmits/receives data (file) under the control of the read/write control unit 170.

In detail, the external network control unit 160 receives the data (file) from the external network connection unit 150. Further, the external network control unit 160 transfers the request of the external network host to the read/write control unit 170. Furthermore, the external network control unit 160 unidirectionally receives the data (file) from the read/write control unit 170, receives a control signal, and operates in response to the received control signal.

The read/write control unit 170 searches for and deletes the data (file) stored in the storage unit 140 at the request of the external network.

In detail, the read/write control unit 170 performs the function of searching for, reading, and deleting the file of the storage unit 140 in response to the request of the external network host. Further, the read/write control unit 170 may perform a file transfer function.

The user input processing unit 180 is an interface for processing the input of the input interface 190, that is, data input via the manual operation of the device itself by a user.

The user input processing unit 180 according to an embodiment of the present invention processes data input via manual operation when it is difficult to perform active operation in the external network.

The input interface 190 is an interface for receiving the input of the user.

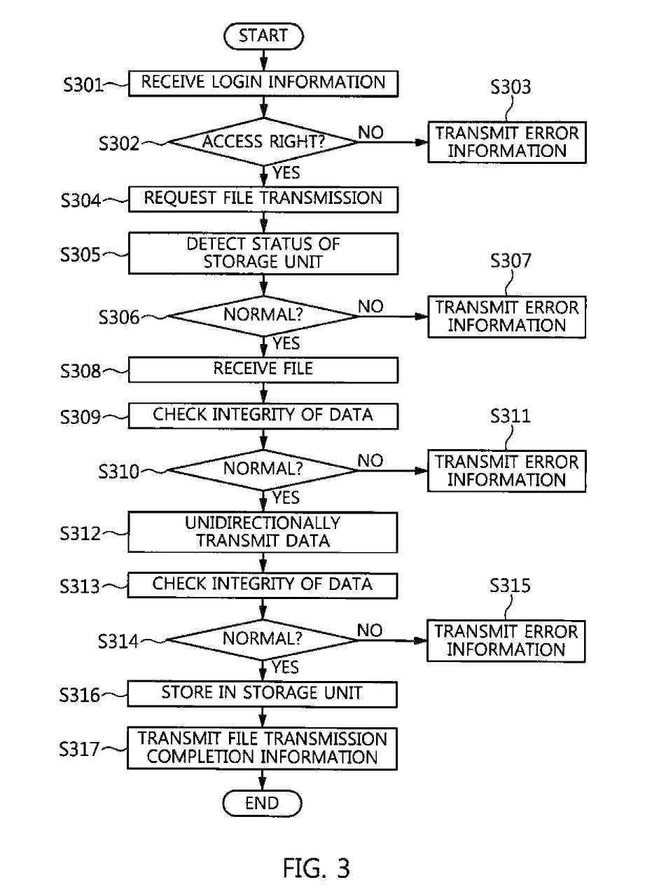

Next, a procedure in which the data transfer apparatus 100 receives a file from the host of the internal network will be described in detail with reference to FIGS. 2 and 3.

FIG. 2 is a flow diagram showing a procedure, in which the data transfer apparatus receives a file from the host of an internal network, with respect to individual steps according to an embodiment of the present invention.

First, a file transfer environment includes the host of an internal network, a control unit, and a storage unit 140.

The internal network host is an agent for transmitting a file.

The control unit is the collective name of components related to the internal network of the data transfer apparatus 100 according to the embodiment of the present invention except for the storage unit 140, that is, the internal network connection unit 110, the internal network control unit 120, and the write control unit 130.

The storage unit 140 is a space for storing a transmitted file and a part associated with the external network.

Referring to FIG. 2, the host of the internal network attempts to access the data transfer apparatus 100 so as to transmit a file.

That is, the internal network host logs in to the control unit of the data transfer apparatus 100 at step S201. The data transfer apparatus 100 checks the Identification (ID), password (PW), Internet Protocol (IP) address, Media Access Control (MAC) address, etc., depending on settings, and determines whether to permit the internal network host to log in to the control unit.

The internal network host performs a transmission initialization procedure at step S202. In this case, the internal network host transmits the file name, file size, and Message Digest algorithm 5 (MD5) value of a file to be transmitted to the control unit. Here, the size and MD5 value of the file correspond to information required to check the integrity of the file after the file has been transmitted.

If the transmission initialization procedure has been completed by the internal network host, the control unit of the data transfer apparatus 100 detects the status of the storage unit 140 at step S203. In detail, the control unit determines whether the storage unit 140 is operating normally, whether the storage function of the storage unit 140 can be used, or whether the same file name is present in the storage unit 140.

Next, the control unit of the data transfer apparatus 100 transfers a transmission permission signal to the internal network host at step S204.

If the transmission permission signal is received from the internal network host, the internal network host starts to transmit actual data (file) at step S205.

The control unit of the data transfer apparatus 100 assembles the transmitted data (file) into a file in a temporary space, and checks the integrity of temporarily stored data (file) after transmission has been completed at step S206. In detail, the control unit of the data transfer apparatus 100 checks the integrity of the temporarily stored data after transmission has been completed, and unilaterally transmits the stored data in the control unit if there is no problem with the integrity of the data, and thereafter rechecks the integrity of the transmitted data.

Then, the control unit of the data transfer apparatus 100 stores the file in the actual storage unit 140 if there is no problem with the integrity of the file at step S207, and deletes the file assembled in the temporary space, that is, the temporarily stored data, at step S208.

The control unit of the data transfer apparatus 100 records the version information of the data (file) in the storage unit at step S209, and notifies the internal network host of the termination of data transmission at step S210.

FIG. 3 is a flowchart showing a procedure for receiving a file from the standpoint of the data transfer apparatus according to an embodiment of the present invention.

Referring to FIG. 3, the data transfer apparatus 100 receives login information from the host of the internal network at step S301. In this case, the login information includes an ID and a password (PW).

The data transfer apparatus 100 determines the access right of the internal network host based on the login information at step S302.

If it is determined at step S302 that the internal network host does not have the access right, the data transfer apparatus 100 transmits error information at step S303.

If it is determined at step S302 that the internal network host has the access right, the data transfer apparatus 100 requests the transmission of a file from the internal network host at step S304. In this case, the data transfer apparatus 100 requests not only the file, but also, the file name, size, and MD5 value of the file.

The data transfer apparatus 100 determines the status of the storage unit 140, such as states indicating whether the storage unit 140 is operating normally, whether the storage function of the storage unit 140 is usable, and whether the same file name is present in the storage unit 140, at step S305.

The data transfer apparatus 100 determines whether the status of the storage unit 140 is normal at step S306.

The data transfer apparatus 100 transmits error information if the status of the storage unit 140 is abnormal at step S307.

The data transfer apparatus 100 receives a file from the internal network host if the status of the storage unit 140 is normal at step S308.

The data transfer apparatus 100 assembles the file received at step S308 in a temporary space, and checks the integrity of temporarily stored data (file) after the reception of the file has been completed at step S309. In this case, the data transfer apparatus 100 checks the integrity of the temporarily stored data, that is, the file, using the MD5 value of the temporarily stored data.

The data transfer apparatus 100 determines whether the results of checking the integrity of the temporarily stored data are normal at step S310.

If the results of checking the integrity of the data are abnormal, the data transfer apparatus 100 transmits error information at step S311.

If the results of checking the integrity of the data are normal, the data transfer apparatus 100 performs the unidirectional (one-way) transmission of data therein, for example, unidirectional transmission of the data from the internal network control unit 120 to the write control unit 130, at step S312.

The data transfer apparatus 100 checks the integrity of the data at step S313.

The data transfer apparatus 100 determines whether the results of checking the integrity of the data are normal at step S314.

If the results of checking the integrity of the data are abnormal, the data transfer apparatus 100 transmits error information at step S315.

If the results of checking the integrity of the data are normal, the data transfer apparatus 100 stores the temporarily stored data in the storage unit 140 at step S316. In this case, the data transfer apparatus 100 stores version information, a transmitter ID, transmission time, etc. related to the temporarily stored data, together with the temporarily stored data.

The data transfer apparatus 100 transfers file transmission completion information to the internal network host at step S317.

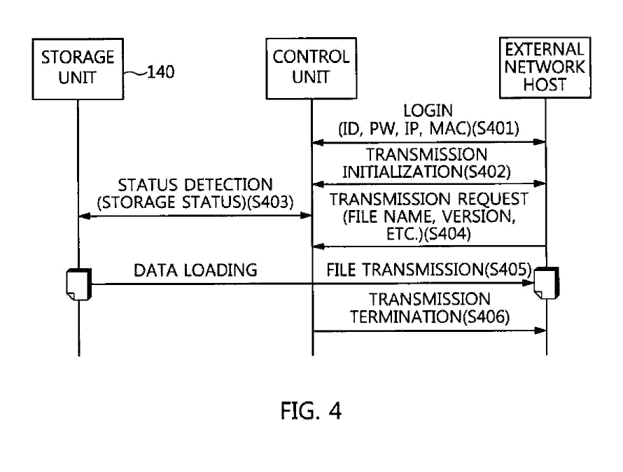

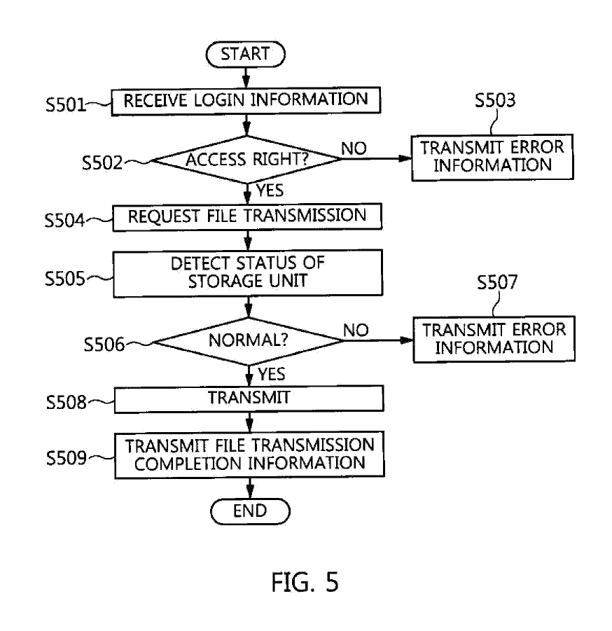

Below, a procedure for transferring the file stored in the storage unit 140 of the data transfer apparatus 100 to the host of the external network will be described in detail with reference to FIGS. 4 and 5.

FIG. 4 is a flow diagram showing a procedure in which the data transfer apparatus transfers a file to the host of an external network according to an embodiment of the present invention.

First, a file transmission environment includes a storage unit 140, a control unit, and the host of an external network.

The storage unit 140 is a space for storing files that are transmitted to the internal network.

The control unit is the collective name of components related to the external network of the data transfer apparatus 100 according to the embodiment of the present invention except for the storage unit 140, that is, the external network connection unit 150, the external network control unit 160, and the read/write control unit 170.

The external network host is a file receiving side.

Referring to FIG. 4, the external network host attempts to access the data transfer apparatus 100 so as to receive a file.

That is, the external network host logs in to the control unit of the data transfer apparatus 100 at step S401. The data transfer apparatus 100 inspects an ID, a password (PW), an IP address, a MAC address, etc. depending on settings, and determines whether to permit the external network host to log in to the control unit.

The external network host performs a transmission initialization procedure at step S402.

The control unit of the data transfer apparatus 100 detects the status of the storage unit 140 if the transmission initialization procedure has been completed by the external network host at step S403. In detail, the control unit determines whether the storage unit 140 is operating normally or whether the data load function of the storage unit 140 is usable.

The external network host transfers a file transmission request to the control unit of the data transfer apparatus 100 using the file name, version, etc. of the file desired to be received at step S404.

The control unit of the data transfer apparatus 100 loads a file corresponding to the file transmission request from the storage unit 140, and transmits the file to the external network host at step S405.

After the transmission of the file has been completed, the control unit of the data transfer apparatus 100 transmits a transmission termination signal to the external network host at step S406.

FIG. 5 is a flowchart showing a procedure for transferring a file from the standpoint of the data transfer apparatus according to an embodiment of the present invention.

Referring to FIG. 5, the data transfer apparatus 100 receives login information from the host of an external network at step S501. In this case, the login information includes an ID and a password (PW).

The data transfer apparatus 100 determines the access right of the external network host based on the login information at step S502.

If it is determined at step S502 that the external network host does not have the access right, the data transfer apparatus 100 transmits error information at step S503.

If it is determined at step S502 that the external network host has the access right, the data transfer apparatus 100 receives a file transmission request from the external network host at step S504. In this case, the external network host transmits the file transmission request to the data transfer apparatus 100 using the file name, version, etc. of a file desired to be received.

The data transfer apparatus 100 detects the status of the storage unit 140, such as states indicating whether the storage unit 140 is operating normally and whether the data load function of the storage unit 140 is usable, at step S505.

The data transfer apparatus 100 determines whether the status of the storage unit 140 is normal at step S506.

If the status of the storage unit 140 is abnormal, the data transfer apparatus 100 transmits error information at step S507.

If the status of the storage unit 140 is normal, the data transfer apparatus 100 loads a file corresponding to the file transmission request from the storage unit 140 and transmits the file to the external network host at step S508.

If the transmission has been completed, the data transfer apparatus 100 transmits a transmission termination signal to the external network host at step S509.

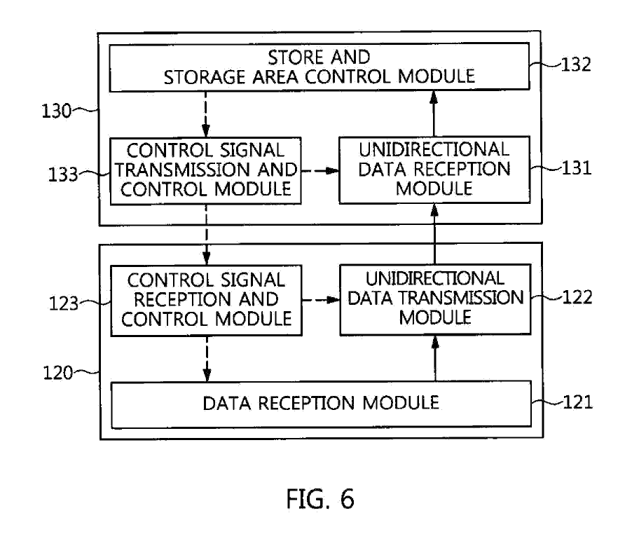

Below, the detailed configuration of the internal network control unit 120 and the write control unit 130 will be described in detail with reference to FIG. 6.

FIG. 6 is a configuration diagram showing the internal network control unit and the write control unit according to an embodiment of the present invention.

Referring to FIG. 6, the internal network control unit 120 includes a data reception module 121, a unidirectional data transmission module 122, and a control signal reception and control module 123.

The data reception module 121 receives data from the host of the internal network through an internal network connection unit.

The unidirectional data transmission module 122 checks the integrity of the received data, and transfers the received data to the unidirectional data reception module 131 of the write control unit 130 via a unidirectional section.

The control signal reception and control module 123 receives a control signal corresponding to the completion of data storage from the control signal transmission and control module 133 of the write control unit 130, and transfers the received control signal to the internal network, thus notifying the internal network that the transmission of the data has been completed.

The write control unit 130 includes a unidirectional data reception module 131, a store and storage area control module 132, and a control, signal transmission and control module 133.

The unidirectional data reception module 131 receives data from the unidirectional data transmission module 122 of the internal network control unit 120.

The store and storage area control module 132 checks the integrity of the received data, and stores the data in the storage unit 140 if there is no problem with the integrity of the data.

The control signal transmission and control module 133 transmits a control signal corresponding to the completion of data storage to the control signal reception and control module 123 of the internal network control, unit 120.

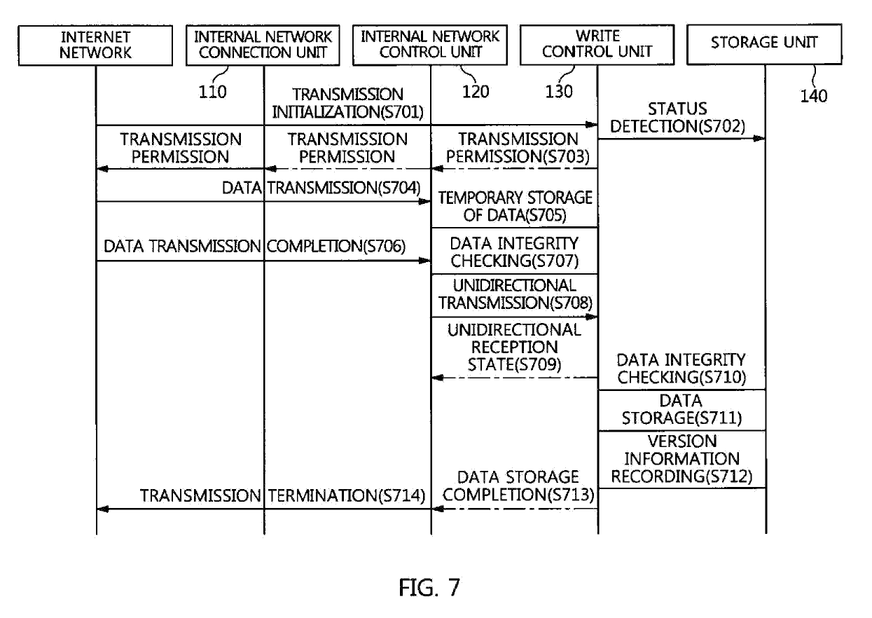

Below, a procedure in which the data transfer apparatus 100 receives a file from the host of the internal network will be described in detail with reference to FIG. 7.

FIG. 7 is a flow diagram showing a detailed procedure, in which the data transfer apparatus receives a file from the host of an internal network, with respect to individual steps, according to an embodiment of the present invention.

First, a file transmission environment includes an internal network host, an internal network connection unit 110, an internal network control unit 120, a write control unit 130, and a storage unit 140.

The internal network host accesses the data transfer apparatus through the internal network connection unit 110 to transmit data (file).

The internal network host performs a transmission initialization procedure to transmit data after accessing the data transfer apparatus at step S701. The transmission initialization procedure is performed to inspect the IP address, MAC address, and ID of the accessing host, that is, the internal network host, depending on settings, and transmit initialization data, including the name and size of a file to be transmitted from the internal network host, and a Message Digest algorithm 5 (MD5) value required to check the integrity of the file, to the data transfer apparatus. The initialization data transmitted from the internal network host is transferred to the write control unit 130 through the internal network connection unit 110 and the internal network control unit 120.

The write control unit 130 detects the status of the storage unit 140 at step S702. In detail, the write control unit 130 determines whether the storage unit 140 is operating normally, whether the storage unit 140 is in a state in which data (file) can be normally recorded, and whether the same file name is present.

The write control unit 130 is configured to, if the same file name is not present in the storage unit 140, transmit a transmission permission signal to the internal network host through the internal network control unit 120 and the internal network connection unit 110 at step S703. Meanwhile, if the same file name is present in the storage unit 140, the write control unit 130 determines whether the version of the file has been updated, and updates version information or stops transmission.

If the transmission permission signal has been received, the internal network host transmits data (file) at step S704. In this case, a response in a Transmission Control Protocol (TCP) is processed by the internal network connection unit 110.

Next, the internal network control unit 120 temporarily stores the received data at step S705.

If the transmission of the data from the internal network host has been completed at step S706, the internal network control unit 120 checks the integrity of the temporarily stored data at step S707, and transfers the temporarily stored data to the write control unit 130 via a unidirectional section at step S708. At step S708, the internal network control unit 120 is in a state in which the data is unidirectionally transmitted to the write control unit 130.

Next, the internal network control unit 120 switches its state to a unidirectional reception state in which a specific control signal can be received from the write control unit 130 at step S709.

The write control unit 130 checks the integrity of the data received at step S708 at step S710. If, as a result of checking the integrity of the data, there is no problem with the integrity of the data, the write control unit 130 stores the data in the storage unit 140 at step S711, and records the version information of the data at step S712.

Then, the write control unit 130 transmits a control signal corresponding to the completion of data storage to the internal network control unit 120 at step at step S713. The internal network control unit 120 transmits the results of transmission to the internal network through the internal network connection unit 110 at step S714.

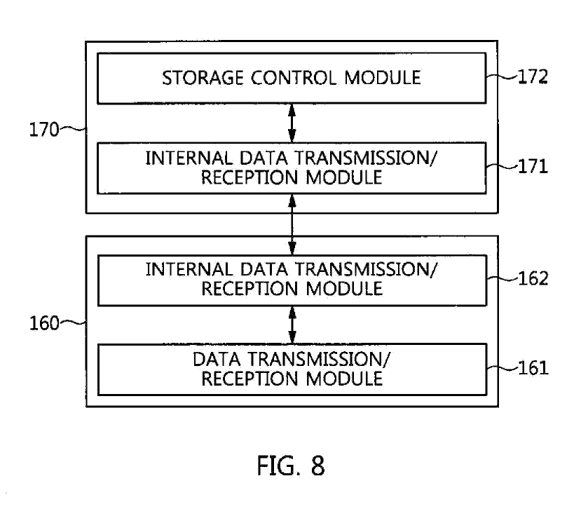

Below, the detailed configuration of the external network control unit 160 and the read/write control unit 170 will be described in detail with reference to FIG. 8.

FIG. 8 is a configuration diagram showing the external network control unit and the read/write control unit according to an embodiment of the present invention.

Referring to FIG. 8, the external network control unit 160 includes a data transmission/reception module 161 and an internal data transmission/reception module 162.

The mad/write control unit 170 includes an internal data transmission/reception module 171 and a storage control module 172.

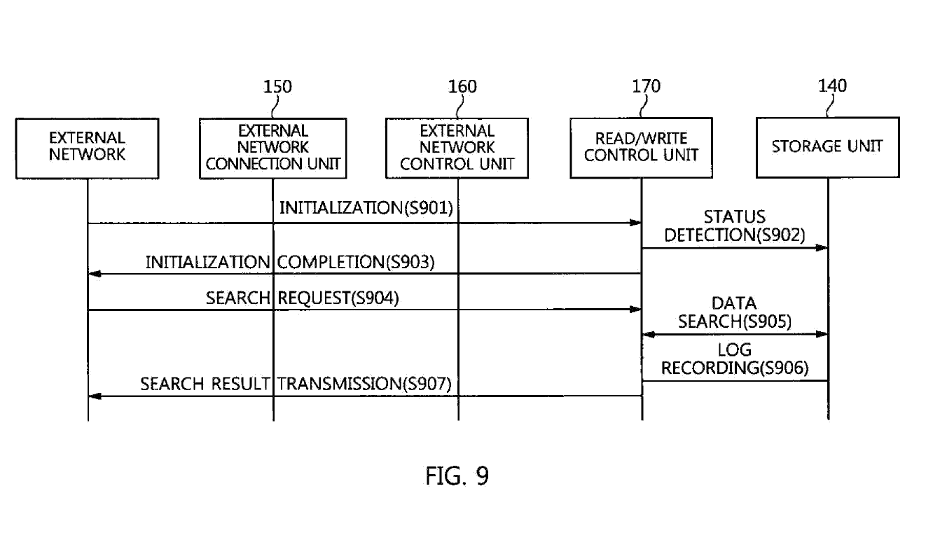

A procedure in which the data transfer apparatus 100 is operated at the request of the external network host will be described in detail with reference to FIGS. 9 to 11.

FIG. 9 is a flow diagram showing an operating procedure performed when the data transfer apparatus receives a data search request from the host of an external network according to an embodiment of the present invention.

Referring to FIG. 9, the external network host accesses the data transfer apparatus through the external network connection unit 150 to search for data (file).

After accessing the data transfer apparatus, the external network host performs a transmission initialization procedure to search for data at step S901. During the transmission initialization procedure, the IP address, MAC address, ID, and password of the accessing host, that is, the external network host, are inspected depending on settings.

The read/write control unit 170 detects the status of the storage unit 140 at step S902, and transmits an initialization completion message to the external network host at step S903.

The external network host sends a file search request to the read/write control unit 170 using the file name, version, etc. of data (file) desired to be searched for at step S904.

The read/write control unit 170 searches for the data (file) corresponding to the file search request at step S905, and records the log corresponding to the found data at step S906.

The read/write control unit 170 transmits the results of searching the data at, step S905 to the external network host at step S907.

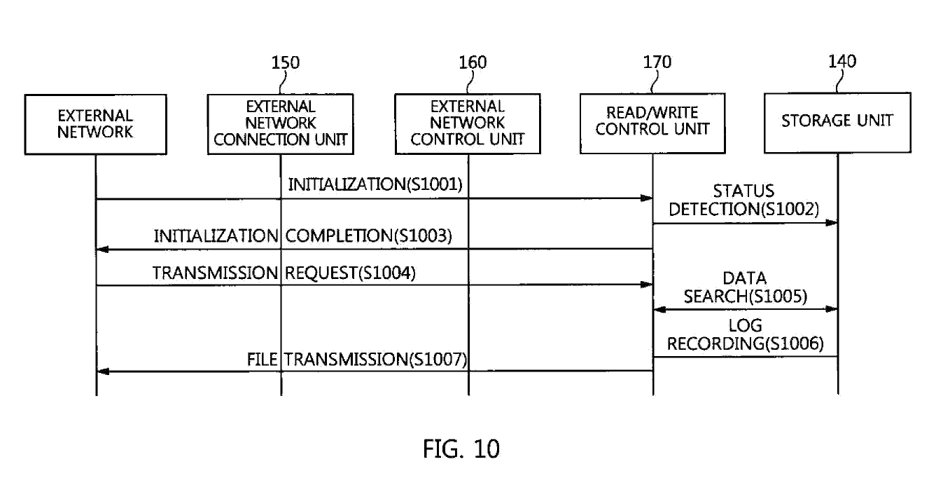

FIG. 10 is a flow diagram showing an operating procedure performed when the data transfer apparatus receives a data reception request from the host of an external network according to, an embodiment of the present invention.

Referring to FIG. 10, the external network host accesses the data transfer apparatus through the external network connection unit 150 to receive data (file).

After accessing the data transfer apparatus, the external network host performs a transmission initialization procedure to receive data at step S1001. During the transmission initialization procedure, the IP address, MAC address, ID, and password of the accessing host, that is, the external network host, are inspected depending on settings.

The read/write control unit 170 detects the status of the storage unit 140 at step S1002, and determines whether an operation such as a file search is possible. Next, the read/write control unit 170 sends a data format initialization completion message to the external network host at step SI003.

The external network host transfers a data format transmission request message, including the file name and version of data (file) desired to be received, to the read/write control unit 170 at step S1004.

The read/write control unit 170 searches for data (file) corresponding to the transmission request message at step S1005, and records the log corresponding to the data at step S1006.

The read/write control unit 170 transmits the results of searching the data at step S1005 to the external network host at step S1007.

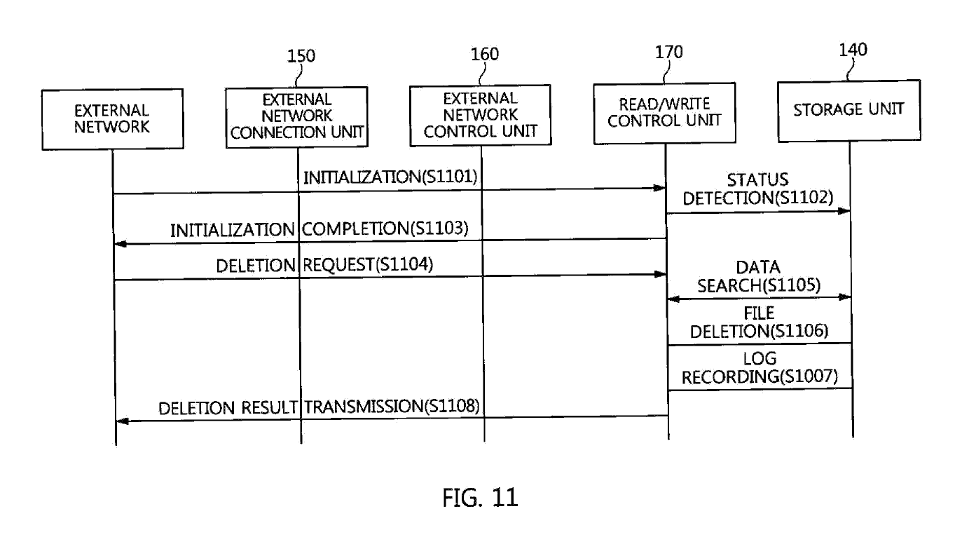

FIG. 11 is a flow diagram showing an operating procedure performed when the data transfer apparatus receives a data deletion request from the external network host according to an embodiment of the present invention.

Referring to FIG. 11, the external network host accesses the data transfer apparatus through the external network connection unit 150 so as to delete data (file).

After accessing the data transfer apparatus, the external network host performs a transmission initialization procedure to delete data at step S1101. During the transmission initialization procedure, the IP address, MAC address, ID, and password of the accessing host, that is, the external network host, are inspected depending on settings.

The read/write control unit 170 detects the status of the storage unit 140 at step S1102, and determines whether the deletion of a file is possible. Then, the read/write control unit 170 sends a data format initialization completion message to the external network host at step S1103.

The external network host transfers a data format deletion request message, including the file name and version of data (file) desired to be deleted, to the read/write control unit 170 at step S1104.

The read/write control unit 170 searches the storage unit 140 for the data (file) corresponding to the deletion request message at step S1105. Then, the read/write control unit 170 deletes the found data (file) from the storage unit 140 at step S1106, and records the log corresponding to the deleted data at step S1107.

The read/write control unit 170 transmits the results of deleting the data at step S1106 to the external network host at step S1108.

As described above, the data transfer apparatus and method according to the embodiments of the present invention can fundamentally block the possibility of intrusion from an external network into an internal network that provides files, and can guarantee the reliability of transmitted data in a situation in which information cannot be exchanged.

In accordance with the present invention, the data transfer apparatus and method can fundamentally block the possibility of intrusion from an external network into an internal network that provides files, and guarantee the stable transmission of data.

The data transfer apparatus according to the embodiments of the present invention is located at a place where a high security level is required and an external contact point is generated if necessary, thus satisfying convenience while maintaining ,a high security level. Further, by means of this, the present invention can contribute to the improvement of network security.

As described above, optimal embodiments of the present invention have been disclosed in the drawings and the specification. Although specific terms have been used in the present specification, these are merely intended to describe the present invention and are not intended to limit the meanings thereof or the scope of the present invention described in the accompanying claims. Therefore, those skilled in the art will appreciate that various modifications and other equivalent embodiments are possible from the embodiments. Therefore, the technical scope of the present invention should be defined by the technical spirit of the claims.

What is claimed is:

1. A data transfer method, comprising:
receiving, by a data transfer apparatus, login information from a host of an internal network, and determining an access right of the internal network host based on the received login information;
if the internal network host has the access right, permitting transmission of data;
detecting status of a storage unit corresponding to an area for storing the data;
if the status of the storage unit is normal, receiving the data from the internal network host, temporarily storing the data, and checking integrity of the temporarily stored data; and
storing the temporarily stored data in the storage unit.

2. The data transfer method of claim 1, wherein checking the integrity of the temporarily stored data comprises:
checking, by an internal network control unit of the data transfer apparatus, integrity of the temporarily stored data;
unidirectionally transmitting, by the internal network control unit, the temporarily stored data to a write control unit of the data transfer apparatus; and
checking, by the write control unit, the integrity of the temporarily stored data.

3. The data transfer method of claim 1, wherein checking the integrity of the temporarily stored data comprises checking the integrity of the temporarily stored data using a Message Digest Algorithm 5 (MD5) value of the login information.

4. A data transfer method, comprising:
receiving, by a data transfer apparatus, login information from a host of an external network, and determining an access right of the external network host based on the received login information;
if the external network host has the access right, receiving a data transmission request from the external network host;
detecting status of a storage unit for storing data; and
if the status of the storage unit is normal, reading data corresponding to the data transmission request from the storage unit and transferring the data to the external network host.

5. The data transfer method of claim 4, further comprising, if the external network host has the access right:
receiving a data search request from the external network host;
searching the storage unit for data corresponding to the data search request; and
transferring results of the search to the external network host.

6. The data transfer method of claim 4, further comprising, if the external network host has the access right:
receiving a data deletion request from the external network host;
searching the storage unit for data corresponding to the data deletion request; and
deleting found data from the storage unit, and transferring results of deleting the data to the external network host.

7. A data transfer apparatus, including a storage unit corresponding to an area for storing data, comprising:
an internal network connection unit for receiving data from a host of an internal network;
an internal network control unit for performing control such that the data is unidirectionally transmitted;
a write control unit for checking integrity of the data received from the internal network control unit and detecting status of the storage unit;
an external network connection unit for receiving a request from a host of an external network; and
a read/write control unit for searching for, reading, and deleting data stored in the storage unit at a request of the external network host.

8. The data transfer apparatus of claim 7, further comprising a user input processing unit for processing data input via manual operation by a user.

9. The data transfer apparatus of claim 7, wherein the internal network control unit comprises:
a data reception module for receiving data from the internal network connection unit;
a unidirectional data transmission module for checking integrity of data received by the data reception module, and transferring the data to the write control unit via a unidirectional section; and
a control signal reception and control module for receiving a control signal corresponding to completion of data storage from the write control unit, and transferring the received control signal to the internal network host, thus notifying the internal network host that transmission of the data has been completed.

10. The data transfer apparatus of claim 7, wherein the write control unit comprises:
a unidirectional data reception module for receiving data from the internal network control unit;
a store and storage area control module for checking integrity of the data, and storing the data in the storage unit if there is no problem with the integrity of the data as a result of checking the integrity; and
a control signal transmission and control module for transmitting a control signal corresponding to completion of data storage to the internal network control unit.
